(19) United States
(12) Patent Application Publication
(10) Pub. No.: US 2004/0189597 A1
(43) Pub. Date: Sep. 30, 2004

(54) Portable wireless terminal

(75) Inventors: Yoshiko Amitani, Osaka (JP); Kensuke Konishi, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SANYO ELECTRIC CO., LTD., Moriguchi-shi (JP); SANYO TELECOMMUNICATIONS CO., LTD., Daito-shi (JP)

(21) Appl. No.: 10/807,178

(22) Filed: Mar. 24, 2004

(30) Foreign Application Priority Data
Mar. 27, 2003 (JP) 2003-086657

(51) Int. Cl. G09G 5/00

(52) U.S. Cl. 345/156

(57) ABSTRACT

The present invention provides a wireless portable terminal comprising a first case and a second case which are interconnected by a hinge mechanism. The second case is closable to a first posture wherein a front surface of the first case is covered, and is openable to a second posture wherein the surface is exposed. A display is arranged on a rear surface of the second case. A pointing device projects from a surface of the first case for performing an input manipulation on a screen presented on the display. A through bore extending through the second case from the front surface thereof to the rear surface thereof is provided at the position opposed to the pointing device when in the first posture.

### FIELD OF THE INVENTION

The present invention relates to portable wireless terminals having a display, such as portable telephones.

### BACKGROUND OF THE INVENTION

Portable telephones generally comprise a flat case provided with a display and key manipulating portion respectively on the upper and lower surfaces thereof. Provided above the display is a receiver. Provided below the key manipulating portion is a transmitter. The key manipulating portion comprises numerical keys for entering telephone numbers and entering text in preparing an e-mail, seesaw key for changing over a screen presented on the display and selecting one menu item from a plurality of menu items presented on the screen of the display.

In recent years, with the portable telephones adapted to have a multiplicity of functions, there is a need to make the seesaw key more convenient and efficient to use. In response to such a need, with the portable telephone disclosed in JP-A No.62984/2002, for example, usable in place of the conventional seesaw is a pointing device for moving a pointer presented on the screen of the display into a given direction.

Known as a foldable portable telephone comprising a main body and a closure case which are openably connected to one another by a hinge mechanism is one provided with displays on each of front and rear surfaces of the closure case for presenting the screen of the display regardless of whether the closure case is opened or closed. For example, the foldable portable telephone shown in FIG. 8 comprises a main body 91 and a closure case 92 which are connected to one another by a hinge mechanism 93. The closure case 92 is openable and closable toward the main body 91.

The main body 91 comprises numerical keys 94 which are disposed on a front surface thereof, a seesaw key 90 which is provided above the numerical keys 94, and a transmitter 96 which is provided below the numerical keys 94. A side key 910 is arranged on a side surface of the main body 91. The closure case 92 comprises a main display 95 which is disposed on a front surface thereof, and a receiver 97 which is provided above the main display 95. With reference to FIG. 9, a sub-display 98 is provided on a rear surface of the closure case 92, and a CCD camera 99 is provided in the vicinity of the sub-display 98. With the foldable portable telephone thus constructed, the input manipulation on the screen presented on the display needs to be made more convenient and efficient.

In response to such a need, it is studied that with a foldable portable telephone shown in FIG. 8, for example, the aforementioned pointing device is provided at the position of the seesaw key 90 in place of the seesaw key 90. When the main body 91 and the closure case 92 of the portable telephone are in an open state, the user can perform the input manipulation on the screen presented on the display 95 by using the pointing device, whereby the manipulation is made more convenient and efficient than conventionally.

However, with the closure case 92 closed to the main body 91, the pointing device, the numerical keys 94, and the main display 95 are altogether hidden behind the main body 91 and the closure case 92, so that the user is forced to perform the input manipulation on the screen presented on the sub-display 98 only by using the side key 910. Accordingly there arises the problem that even the provision of the pointing device cannot make the manipulation on the screen presented on the sub-display more convenient and efficient when the foldable portable telephone is in the closed state.

### SUMMARY OF THE INVENTION

An object of the present invention is to provide a portable wireless terminal wherein two cases can be opened or closed, and to make an inputting manipulation on a screen presented on a display of the terminal more convenient and more efficient than conventionally.

The portable wireless terminal embodying the present invention comprises a first case 1 having a front surface and a rear surface, a second case 2 having a front surface and a rear surface, an interconnecting mechanism for interconnecting the two cases 1, 2. The second case 2 has a display 5 disposed thereon. The second case 2 and the first case 1 are interconnected by the interconnecting mechanism so that the second case 2 is closable to a first posture wherein at least a part area of front surface of the first case 1 is covered and is openable to a second posture wherein the part area is exposed. The display 5 is arranged at a position such that the display 5 is exposed regardless of whether the second case 2 is set to the first posture or to the second posture. The part area has a pointing device 4 projecting therefrom in a direction apart from the front surface of the first case 1 and for an input manipulation on a screen presented on the display 5. The second case 2 has an opening extending through the case 2 from the front surface thereof to the rear surface thereof at the position opposed to the pointing device 4 when in the first posture. The pointing device 4 is, for example, in the form of a bar, and is movable so as to tilt upwardly, downwardly, rightwardly or leftwardly with its base end serving as a fulcrum.

When the second case 2 of the portable wireless terminal is set to the first posture, the pointing device 4 extends through the opening to have its outer end projecting toward the surface including the display 5. This enables the user to perform the input manipulation on the screen presented on the display 5 by using the pointing device 4. Accordingly the input manipulation is made more convenient and efficient than conventionally on the screen presented on the display 5 to be operated with the two cases 1, 2 closed.

Stated specifically, the interconnecting mechanism comprises a hinge mechanism 3 for openably interconnecting the first case 1 and the second case 2. While the front surface of the second case 2 is opposed to the front surface of the first case 1 in the first posture, the front surface of the second case 2 is apart from the front surface of the first case 1 in the second posture. While the display 5 is disposed on the rear surface of the second case 2 serving as a sub-display, a main display 50 is disposed on the front surface of the second case 2. The opening provides a through bore 27 having an inner peripheral wall to surround the pointing device 4. While the pointing device 4 functions for a screen presented on the sub-display 5 in the first posture, the pointing device 4 functions for a screen presented on the main display 50 in the second posture.

According to the specific construction, when the two cases 1, 2 are opened to set the second case 2 to the second posture, the main display 50 disposed on the front surface of the second case 2 is exposed and the pointing device 4 is exposed flush with the surface of the main display 50. The manipulation on the screen presented on the main display 50 is thus performed by the pointing device 4.

When the two cases 1, 2 are closed to set the second case 2 to the first posture, the pointing device 4 extends through the bore 27 to have its outer end projecting toward the rear surface of the second case 2 including the sub-display 5. This enables the user to perform the input manipulation on the screen presented on the sub-display 5 by the pointing device 4.

The input manipulation on the screen presented on the main display 50 exposed with the two cases 1, 2 set to the open state is, therefore, made more convenient and more efficient than conventionally. In addition to this, the input manipulation on the screen presented on the sub-display 5 to be operated with the two cases 1, 2 closed is also made more convenient and more efficient than conventionally.

Stated further specifically, the hinge mechanism 3 comprises a first barrel portion 13 which is provided on an upper end of the first case 1 and a second barrel portion 23 which is provided on a lower end of the second case 2, and the first and second barrel portions are interconnected coaxially to move rotatably relative to one another. The pointing device 4 is provided on the first barrel portion 13.

Stated specifically, the pointing device 4 is provided on the first barrel portion 13 constituting the hinge mechanism 30, so that there is no need to provide space for the pointing device 4 on the front surface of the first case 1, whereby the aforementioned part area can be reduced and the first case 1 can thus be made compact.

Stated further specifically, the interconnecting mechanism comprises a sliding mechanism for slidably interconnecting the first case 1 and the second case 2 one another. The two cases 1, 2 are slidably lapped over one another with the front surface of the first case 1 opposed to the rear surface of the second case 2. While the two cases are lapped over in the greatest area in the first posture, the two cases are lapped over in the smallest area in the second posture. A display 5a is disposed on the front surface of the second case 2, and the opening 27 is formed by a notch 28 having a U-shaped opening opposed to the pointing device 4.

According to the specific construction, when the two cases 1, 2 are opened to set the second case 2 to the second posture, the display 5a disposed on the front surface of the second case 2 is exposed and the pointing device 4 is exposed flush with the surface of the display 5a. The manipulation on the screen presented on the display 5a is thus performed by the pointing device 4.

Furthermore, when the two cases 1, 2 are closed to set the second case 2 to the first posture, the pointing device 4 is accommodated into the notch 28 to have its outer end projecting toward the front surface of the second case 2 including the display 5a. The input manipulation on the screen presented on the display 5a is thus performed by the pointing device 4.

Therefore the input manipulation on the screen presented on the display 5a can thus be performed by the pointing device 4 regardless of the two cases 1,2 are opened or closed, to thereby make the input manipulation for the display 5a more convenient and more efficient.

As described above, the portable wireless terminal of the present invention enables its user to perform the input manipulation on the screen presented on the display to be operated by using the pointing device regardless of whether the two cases are opened or closed, whereby the manipulation is made more convenient and more efficient than conventionally.

### BRIEF DESCRIPTION OF THE DRAWINGS

FIG. 1 is a perspective view showing a foldable portable telephone in an opened state embodying the present invention;

FIG. 2 is a perspective view showing the foldable portable telephone in a closed state embodying the present invention;

FIG. 3 is a front view showing the foldable portable telephone in a game-playing state when it is closed;

FIG. 4 is a perspective view showing a slidable portable telephone in an opened state embodying the present invention;

FIG. 5 is a perspective view showing the slidable portable telephone in a closed state;

FIG. 6 is a perspective view showing another foldable portable telephone in an opened state embodying the present invention;

FIG. 7 is a perspective view showing the foldable portable telephone in a closed state embodying the present invention;

FIG. 8 is a perspective view showing a conventional foldable portable telephone;

FIG. 9 is a perspective view showing a rear surface of the foldable portable telephone.

### DETAILED DESCRIPTION OF EMBODIMENTS

The present invention as applied to a foldable portable telephone and a slidable portable telephone will be described below with reference to drawings.

Foldable Portable Telephone

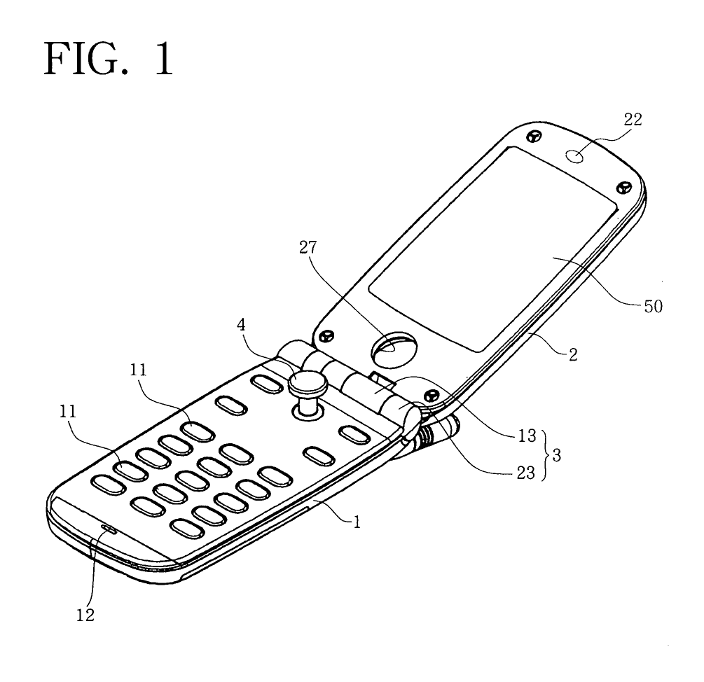

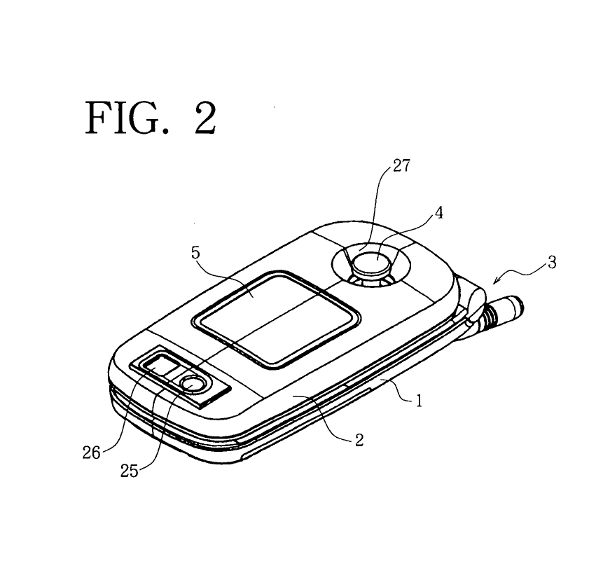

A foldable portable telephone embodying the present invention comprises a flat first case 1 and a flat second case 2 which are interconnected by a hinge mechanism 3 as seen in FIG. 1. The hinge mechanism 3 comprises a first barrel portion 13 which is provided on an upper end of the first case 1 and a second barrel portion 23 which is provided on a lower end of the second case 2, and the first and second barrel portions are interconnected coaxially to move rotatably relative to one another, whereby the two cases 1, 2 are openable to a state wherein each of the front surfaces of the two cases 1, 2 is exposed as shown in FIG. 1, and closable to a state wherein each of the front surfaces of the two cases 1, 2 is opposed to one another as shown in FIG. 2.

The first case 1 has numerical keys 11 arranged on its front surface. A pointing device 4 in the form of a bar projects above the numerical keys 11. The pointing device 4 is movable so as to tilt upwardly, downwardly, rightwardly or leftwardly with its base end serving as a fulcrum. Furthermore a transmitter 12 is provided below the numerical keys 11.

The second case 2 has a main display 50 disposed on its central front surface. A receiver 22 is provided above the main display 50. The second case 2 has a sub-display 5 disposed on its central rear surface as shown in FIG. 2. A CCD camera 25 and a flash 26 are arranged in the vicinity of the sub-display 5.

Furthermore, as seen in FIG. 1, provided below the main display 50 is a through bore 27 in a circular form and extending through the second case 2 from the front surface thereof to the rear surface thereof and positioned as opposed to the pointing device 4 when the two cases 1, 2 are set to the closed state. An inner peripheral wall of the through bore 27, as seen in FIG. 2, is formed in a cone-shaped hollow such that the inner peripheral wall will gradually be increased in diameter from the front surface to the rear surface of the second case 2.

When the two cases 1, 2 are set to the closed state, the pointing device 4 extends through the through bore 27, to have its outer end projecting toward the rear surface of the second case 2 including the sub-display 5.

The foldable portable telephone, with the two cases 1, 2 closed as seen in FIG. 2, is held in a pocket of clothes or in a bag and is carried by the user. At this time the main display 50 is hidden behind the first case 1 and the second case 2, and is, therefore, free from damage due to act of external forces. Furthermore the numerical keys 11 are also hidden behind the first case 1 and the second case 2, so that there is no likelihood that depressing the numerical keys 11 causes misoperation.

In this state the second case 2 is opened toward the first case 1 as seen in FIG. 1 to thereby expose the numerical keys 11 and the pointing device 4 which are arranged on the front surface of the first case 1, and to expose the main display 50 which is arranged on the front surface of the second case 2. Setting the two cases 1, 2 to the opened state makes it possible to present a screen on the main display 50, enabling the user to perform a key input manipulation by the numerical keys 11, and further enabling the user to perform a key input manipulation by the pointing device 4, with the main display 50 serving as the display screen (second posture).

This state allows the user to make a call and receive a call, to prepare an e-mail to be transmitted, to browse a received e-mail, to play games, to manipulate application downloaded from a Web site, and to take a picture with a camera 42. In order to perform these operations, the user depresses the numerical keys 11 for a simple input manipulation, and manipulates the pointing device 4 for selecting one menu item from a plurality of menu items presented on the screen of the main display 50 and for successively changing over the screens presented on the main display 50.

For example, in the case where the user inputs text for the preparation of an e-mail to be transmitted, the user manipulates the pointing device 4 with figures presented on the screen of the main display 50 to select a desired figure from the figures by moving a cursor on the screen. Further in the case where the user reads a received e-mail, the user manipulates the pointing device 4 with e-mails, which are recorded in an incorporated memory, presented on the screen of the main display 50 to select a desired e-mail from the e-mails by moving a cursor on the screen.

In the case where the user takes a still picture or motion picture with a CCD camera 25, the picture taken by the CCD camera 25 is presented on the screen of the main display 50. In this state the user manipulates the pointing device 4 to adjust zoom of the CCD camera 25, to adjust brightness of the picture, to provide special effects by inverting the image presented on the screen of the main display 50 and by changing over the image to a mosaic image.

Furthermore in the case where the user accesses a Web site to browse Web pages, the user manipulates the pointing device 4 with the Web page presented on the screen of the main display 50 to change over the Web page to the next page. Further in the case where the user plays the game recorded in the incorporated memory, the user manipulates the pointing device 4 with the game presented on the screen of the main display 50 to manipulate a character image presented on the screen of the main display 50.

Furthermore, in the case where the user downloads the vicinity map for the user's location from a Web site, the user manipulates the pointing device 4 with the vicinity map for the user's location presented on the screen of the main display 50 to move a pointer on the screen, whereby the user can select one of objects dotted with the map presented on the screen of the main display 50, and can further download detailed information on the object.

The portable telephone in the opened state shown in FIG. 1 is brought to the closed state with the respective front surfaces of the first case 1 and the second case 2 opposed to one another as shown in FIG. 2, to thereby have hidden behind the first and second cases 1, 2 therebetween the numerical keys 11 arranged on the front surface of the first case 1 and the main display 50 arranged on the front surface of the second case 2. On the other hand the pointing device 4 extends through the through bore 27 of the second case 2, to have an outer end projecting toward the rear surface of the second case 2 including the sub-display 5. Thus setting the two cases 1, 2 to the closed state makes it possible to present a screen on the sub-display 5 to thereby perform the input manipulation by the pointing device 4 with the sub-display 5 for presenting the screen.

Even when the two cases 1, 2 are set to the closed state, the user can browse the received e-mail, play the games, manipulate application downloaded from a Web site, and take a picture with a camera, as described.

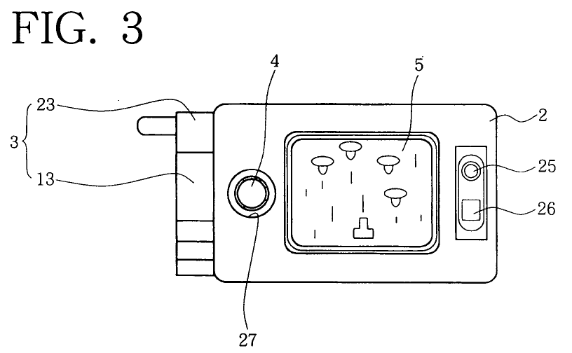

To take an example of playing the game recorded in the incorporated memory, the image is presented on the sub-display 5 as changed over in direction by 90 degrees relative to the screen when the two cases 1, 2 are set to the closed state, to thereby present the image on the laterally elongated screen which is set as a normal direction as seen in FIG. 3. The game is presented on the screen of the sub-display 5 wherein the screen is changed over in direction, to enable the user to manipulate the pointing device 4 to be positioned at left side of the sub-display 5 to thereby manipulate the character presented on the screen of the display 5.

When the two cases 1, 2, of the foldable portable telephone embodying the present invention are set to the opened state, the user can perform the input manipulation on the screen presented on the main display 50 by the pointing device 4, whereby the input manipulation on the screen presented on the main display 50 exposed in the opened state is made more convenient and efficient than conventionally. Further when the two cases 1, 2 are in the closed state, the user can perform the input manipulation on the screen presented on the sub-display 5 by the pointing device 4, whereby the input manipulation on the screen presented on the sub-display 5 exposed in the closed state is made more convenient and efficient than conventionally.

Slidable Portable Telephone

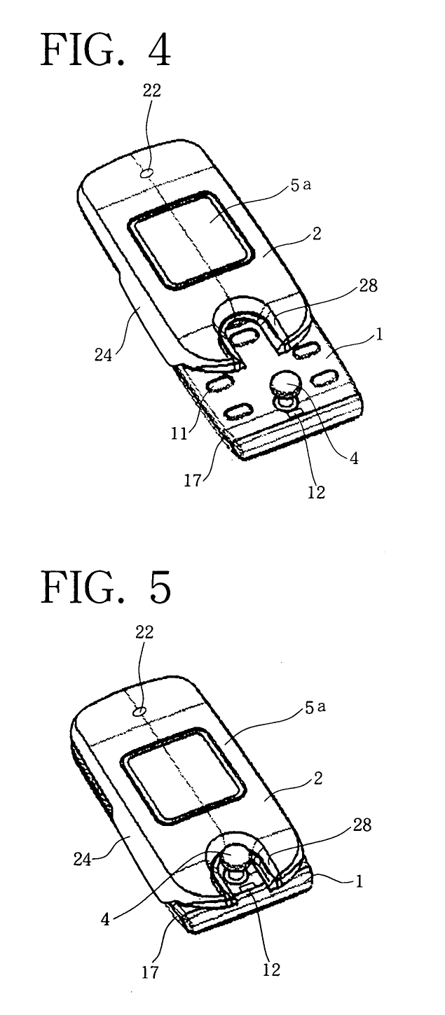

A slidable portable telephone of the present invention comprises a flat first case 1 and a flat second case 2 as seen in FIG. 4 which are lapped over and slidably in engagement with one another. The sliding manipulation makes it possible to close the telephone as shown in FIG. 5, and to open the telephone as shown in FIG. 4. With reference to FIG. 4, a plurality of manipulation keys 11 are arranged on a front surface of the first case 1, and a transmitter 12 is provided on a lower end portion thereof. A pointing device 4 in the form of a bar projects above the transmitter 12. The pointing device 4 is movable so as to tilt upwardly, downwardly, rightwardly or leftwardly with its base end serving as a fulcrum. A pair of slide grooves 17, 17 extending in the direction of sliding of the second case 2 is provided on opposite side faces of the first case 1.

A display 5a is arranged at the central portion of front surface of the second case 2. A receiver 22 is provided above the display 5a. A pair of rail portions 24, 24 to hold the first case 1 is provided on opposite side faces of the second case 2. A pair of projections (not shown) to be slidably in engagement with slide grooves 17, 17 is provided on the pair of rail portions 24, 24, respectively.

A notch 28 having a U-shaped opening opposed to the pointing device 4 is formed below the display 5a. A peripheral wall of the notch 28, as seen in FIG. 4, is formed in a cone-shaped hollow such that the hollow will gradually be increased in cross section from the rear surface to the front surface of the second case 2.

The pointing device 4 is thus accommodated into the notch 28 when the two cases 1, 2 are set to the closed state as seen in FIG. 5. An outer end of the device 4 projects toward the front surface of the second case 2 including the display 5a.

The second case 2 in its closed state shown in FIG. 5 is depressed upwardly, sliding the projection provided on the rail portion 24 of the second case 2 along the guide groove 17 of the first case 1, to guide the second case 2 to moving, to set the two cases 1, 2 to the opened state such that the cases are lapped over one another in the smallest area as shown in FIG. 4. Furthermore the second case 2 in its opened state shown in FIG. 4 is depressed downwardly, to guide the second case 2 to moving by the rail portion 24 of the second case 2, to set the two cases 1, 2 to the closed state such that the cases are lapped over one another in the greatest area as shown in FIG. 5.

The slidable portable telephone, with the two cases 1, 2 closed as seen in FIG. 5, is held in a pocket of clothes or in a bag and is carried by the user. At this time the numerical keys 11 are covered with the second case 2 as hidden, so that there is no likelihood that depressing the numerical keys 11 causes misoperation.

In this state the second case 2 is opened toward the first case 1 as seen in FIG. 4 to thereby expose the numerical keys 11 and the pointing device 4 which are arranged on the front surface of the first case 1. At this time the key input manipulation is performed by the numerical keys 11 and the input manipulation is also performed by the pointing device 4 with the display 5a serving as a display screen.

This state allows the user to make and receive a call, to prepare an e-mail to be transmitted, to browse a received e-mail, to play games, and to manipulate application downloaded from a Web site. In order to perform these operations, the user depresses the numerical keys 11 for a simple input manipulation, and manipulates the pointing device 4 for selecting one menu item from a plurality of menu items presented on the screen of the display 5a and for successively changing over the screens presented on the display 5a.

The second case 2 in the opened state as shown in FIG. 4 is slid along the first case 1, and the two cases 1, 2 are lapped over one another to the closed state as shown in FIG. 5, to thereby cover the numerical keys 11 arranged on the front surface of the first case 1 with the second case 2. On the other hand, the pointing device 4 is accommodated into the notch 28 of the second case 2, and its outer end projects toward the front surface of the second case 2 provided with the display 5a. At this time the input manipulation is performed by the pointing device 4 with the display 5a serving as a display screen. As a result even when the two cases 1, 2 are set to the closed state, the user can browse a received e-mail, play games, and manipulate application downloaded from a Web site.

With the slidable portable telephone of the present invention, when the two cases 1, 2 are in the opened state, the user can perform the input manipulation by the pointing device 4 on the screen of the display 5a. When the two cases 1, 2 are in the closed state, the user can also perform the input manipulation by the pointing device 4 on the screen of the display 5a. Consequently the input manipulation on the screen presented on the display 5a is made more convenient and efficient than conventionally regardless of whether the two cases are opened or closed.

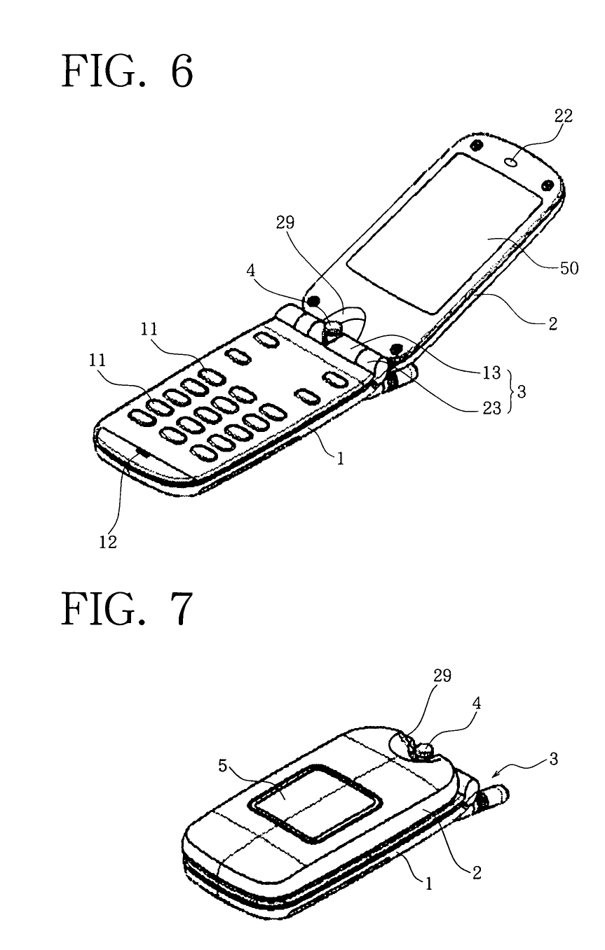

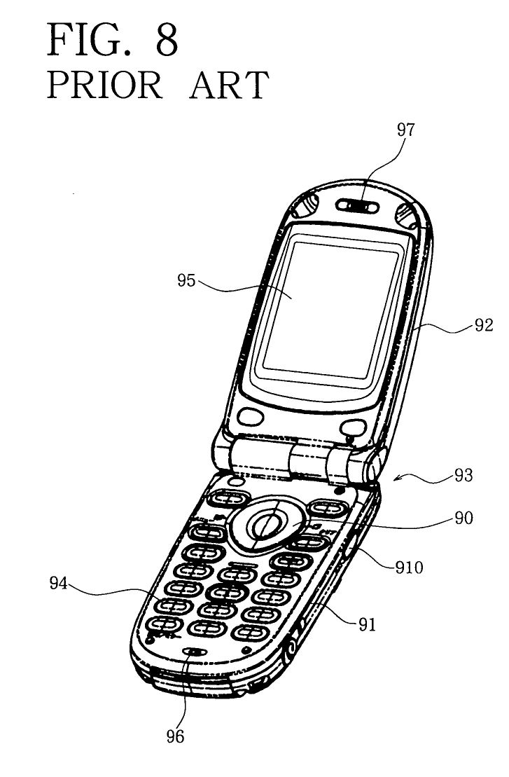

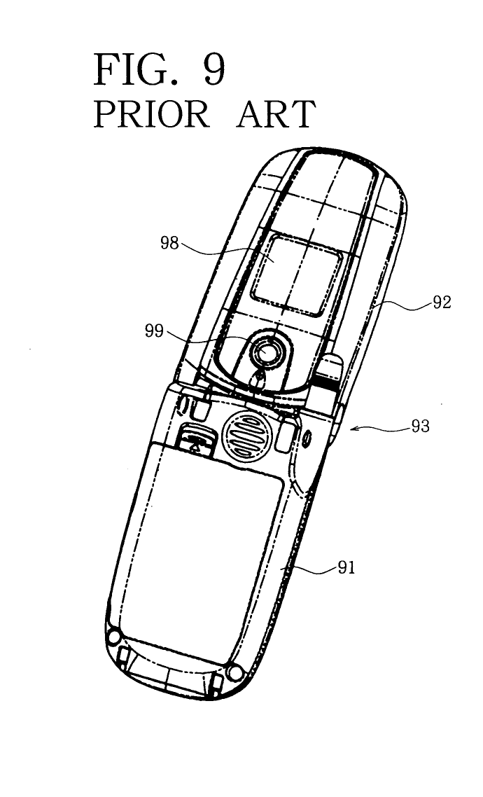

The portable wireless terminal of the present invention is not limited to the foregoing embodiments in construction but can be modified variously by one skilled in the art without departing from the spirit of the invention as set forth in the appended claims. For example, as shown in FIGS. 6, 7, a pointing device 4 projects from a first barrel portion 13 providing a hinge mechanism 3, and an opening of the second case 2 is formed by a U-shaped notch 29 opened toward the hinge mechanism. The same advantages as the above examples are available in this case. Further, the same advantages as the above examples are also available in the case where a plurality of manipulation keys are provided on the rear surface of the second case 2 of the foldable portable telephone. The same advantages as the above examples are further available in the case where a plurality of manipulation keys are provided on the front surface of the second case 2 of the slidable portable telephone, or a CCD camera is provided on the front surface of the second case 2.

What is claimed is:

1. A portable wireless terminal comprising a first case having a front surface and a rear surface, a second case having a front surface and a rear surface and provided with a display, and an interconnecting mechanism for interconnecting the two cases, the second case connecting to the first case by the interconnecting mechanism so that the second case is closable to a first posture wherein at least a part area of front surface of the first case is covered and is openable to a second posture wherein the part area is exposed, the display being arranged at a position such that the display is exposed regardless of whether the second case is set to the first posture or to the second posture, the part area having a pointing device projecting therefrom in a direction apart from the front surface of the first case and for an input manipulation on a screen presented on the display, the second case having an opening extending through the case from the front surface thereof to the rear surface thereof at the position opposed to the pointing device when in the first posture.

2. A portable wireless terminal according to claim 1 wherein the pointing device is in the form of a bar, and is movable so as to tilt upwardly, downwardly, rightwardly or leftwardly with its base end serving as a fulcrum.

3. A portable wireless terminal according to claim 1 wherein the interconnecting mechanism comprises a hinge mechanism for openably interconnecting the first case and the second case, the front surface of the second case is opposed to the front surface of the first case in the first posture; in the meantime, the front surface of the second case is apart from the front surface of the first case in the second posture, the display is disposed on the rear surface of the second case serving as a sub-display; in the meantime, a main display is disposed on the front surface of the second case, the opening provides a through bore having an inner peripheral wall to surround the pointing device, the pointing device functions for a screen presented on the sub-display in the first posture; in the meantime, the pointing device functions for a screen presented on the main display in the second posture.

4. A portable wireless terminal according to claim 3 wherein the hinge mechanism comprises a first barrel portion which is provided on an upper end of the first case and a second barrel portion which is provided on a lower end of the second case, and the first and second barrel portions are interconnected coaxially to move rotatably relative to one another, the pointing device is provided on the first barrel portion.

5. A portable wireless terminal according to claim 1 wherein the interconnecting mechanism comprises a sliding mechanism for slidably interconnecting the first case and the second case one another, the two cases are slidably lapped over one another with the front surface of the first case opposed to the rear surface of the second case, the two cases are lapped over in the greatest area in the first posture; in the meantime, the two cases are lapped over in the smallest area in the second posture, the display is disposed on the front surface of the second case, and the opening is formed by a notch having a U-shaped opening opposed to the pointing device.
